(19) United States
(12) Patent Application Publication
(10) Pub. No.: US 2012/0299398 A1
(43) Pub. Date: Nov. 29, 2012

(54) MOTOR, DESIGN METHOD AND MANUFACTURING METHOD OF MOTOR, STAGE DEVICE, AND EXPOSURE APPARATUS

(75) Inventor: Shigeru MORIMOTO, Kumagaya-shi (JP)

(73) Assignee: NIKON CORPORATION, Tokyo (JP)

(21) Appl. No.: 13/477,585

(22) Filed: May 22, 2012

Related U.S. Application Data
(60) Provisional application No. 61/489,078, filed on May 23, 2011.

(51) Int. Cl. H02K 1/06; H02K 1/02; H02K 41/02

(52) U.S. Cl. 310/12.24; 310/12.04; 310/10; 29/596

(57) ABSTRACT

A distribution of an element to improve coercivity for each magnet is decided, based on analysis results of magnetic fields within a plurality of magnets (M₂₆ and the like), and by structuring each of the plurality of magnets based on the distribution, it becomes possible to realize a permanent magnet having strong magnetic force and high heat-resisting performance whose residual magnetic flux density and coercivity are both improved, using a small amount of an element which improves coercivity. And, by designing a magnet unit using the permanent magnet, and a motor using the magnet unit, it becomes possible to obtain a motor with high performance.

### CROSS-REFERENCE TO RELATED APPLICATIONS

This non-provisional application claims the benefit of Provisional Application No. 61/489,078 filed May 23, 2011, the disclosure of which is hereby incorporated herein by reference in its entirety.

### BACKGROUND OF THE INVENTION

1. Field of the Invention

The present invention relates to motors, design methods and manufacturing methods of motors, stage devices, and exposure apparatuses, and more particularly, to a motor structured using a magnet unit including a plurality of magnets and a coil unit including a plurality of coils, a design method and a manufacturing method of the motor, a stage device provided with the motor, and an exposure apparatus provided with the stage device.

2. Description of the Background Art

As a driving source of magnetic levitation trains, electrically-powered cars, hybrid cars, machine tools, movable stages of exposure apparatuses and the like, motors and the like which generate a force through the interaction of a magnetic field and an electric current are used, such as a linear motor to obtain a linear motion, a rotary motor to obtain a rotational motion, and also a planar motor to obtain a planar motion. These motors are structured so that one of a magnet unit including a plurality of permanent magnets and a coil unit including a plurality of coils serves as a mover (or a rotor) while the other serves as a stator, and the mover is driven in a uniaxial direction, a rotation direction, or a planar direction with respect to the stator.

Performance of the motors described above depends heavily on the properties of the permanent magnets. Properties used to describe the permanent magnets are, for example, residual magnetic flux density Br, coercivity Hc, BH product (or maximum energy product BHₘₐₓ) and the like. Here, residual magnetic flux density Br is the magnetic flux density remaining when the intensity of the magnetic field in a hysteresis curve (demagnetizing curve) becomes zero, and coercivity Hc is the intensity of the demagnetization field required to reduce the magnetic flux density to zero.

Making a strong permanent magnet requires high residual magnetic flux density Br and high coercivity Hc (and also high BHₘₐₓ). Since the intensity of a magnet is proportional to the magnetic flux density, a magnet with higher residual magnetic flux density Br makes a stronger magnet. Furthermore, a magnet with higher coercivity Hc can continue to maintain higher magnetic force in a stable manner.

As strong permanent magnets used in motors, rare earth-containing magnets are promising. Representing such magnets are; samarium-cobalt magnet (Sm₂Co₁₇); neodymium iron boron magnet (Nd₂Fe₁₄B), and the like. These magnets, however, possess properties of demagnetizing under a high temperature environment. Therefore, to increase coercivity Hc, for example, dysprosium Dy can be added (for example, refer to U.S. Patent Application Publication No. 2008/0245442). With dysprosium Dy, however, there is a problem of dysprosium being expensive, with prices being unstable. Further, by adding dysprosium Dy, residual magnetic flux density Br decreases. Therefore, it was difficult to increase both residual magnetic flux density Br and coercivity Hc (also, BHₘₐₓ) using only a small amount of dysprosium Dy.

### SUMMARY OF THE INVENTION

The present invention was made under the circumstances described above, and from a first aspect, the present invention is a design method of a motor which is structured using a magnet unit including a plurality of magnets and a coil unit including a plurality of coils, the method comprising: deciding a distribution of an element which improves coercivity inside the plurality of magnets for each of the plurality of magnets, based on results of an analysis performed of a magnetic field induced by the plurality of magnets included in the magnet unit arranged corresponding to the coil unit; and designing the magnet unit using the plurality of magnets which are each structured based on the distribution of the element which improves the coercivity.

According to this method, the distribution of the element which improves coercivity for each of the plurality of magnets is decided, based on results of the analysis of magnetic fields within the plurality of magnets, and the plurality of magnets are each structured based on the distribution. This allows a permanent magnet having strong magnetic force and high heat-resisting performance whose residual magnetic flux density and coercivity are both improved to be realized, using a small amount of an element which improves coercivity. And, by designing a magnet unit using the permanent magnet, and a motor using the magnet unit, it becomes possible to improve the performance of the motor.

From a second aspect, the present invention is a manufacturing method of a motor, comprising: designing a motor using the design method of a motor of the present invention; and manufacturing the motor according to results of the designing.

According to this method, a motor having a large driving force can be manufactured.

From a third aspect, the present invention is a first motor which is designed using the design method of a motor of the present invention, and is manufactured according to results of the design.

According to this motor, a motor having a large driving force can be obtained.

From a fourth aspect, the present invention is a second motor which is structured using a magnet unit including a plurality of magnets and a coil unit including a plurality of coils, wherein the magnet unit is designed using the plurality of magnets which are each structured based on a distribution of an element which improves coercivity inside the plurality of magnets for each of the plurality of magnets, the distribution being decided based on results of analyzing a magnetic field induced by the plurality of magnets included in the magnet unit arranged corresponding to the coil unit.

According to this motor, the distribution of the element which improves coercivity for each of the plurality of magnets is decided, based on results of the analysis of magnetic fields within the plurality of magnets, and the plurality of magnets are each structured based on the distribution. This allows a permanent magnet having strong magnetic force and high heat-resisting performance whose residual magnetic flux density and coercivity are both improved to be realized, using a small amount of an element which improves coercivity. And, by designing a magnet unit using the permanent magnet, and a motor using the magnet unit, it becomes possible to improve the performance of the motor.

From a fifth aspect, the present invention is a stage device, comprising: the second motor of the present invention; a stage support member in which one of the magnet unit and the coil unit structuring the motor is provided; and a stage in which the other of the magnet unit and the coil unit is provided, and is supported by the stage support member.

According to this stage device, a stage device which can perform a high speed drive can be obtained.

From a sixth aspect, the present invention is an exposure apparatus which transfers a pattern formed on a mask onto an object, the apparatus comprising: the stage device of the present invention serving as a moving device of at least one of the mask and the object.

According to this apparatus, an exposure apparatus having a high throughput that drives at least one of a mask and an object at a high speed can be obtained.

### BRIEF DESCRIPTION OF DRAWINGS

In the accompanying drawings;

FIG. 1A is a perspective view indicating an external appearance of a linear motor related to an embodiment, and FIG. 1B is an XY sectional view of the linear motor;

FIG. 2A is an enlarged view of a YZ cross-section of the linear motor, and FIG. 2B is a view showing an arrangement and directions of magnetic poles of permanent magnets included in a mover (magnet unit);

FIG. 3A is a view showing an arrangement of permanent magnets within a magnet unit, FIG. 3B is a view showing a magnetic flux density distribution within the permanent magnets in the magnet unit obtained by a magnetic field analysis, and FIG. 3C is an enlarged view showing ellipse C in FIGS. 3A and 3B;

FIGS. 4A and 4B are views showing results of demagnetization evaluation of the permanent magnets;

FIG. 5 is a chart showing results on performance evaluation of the linear motor;

FIG. 6 is a perspective view showing a schematic structure of an exposure apparatus of an embodiment; and

FIG. 7 is a perspective view showing a schematic structure of a reticle stage device.

### DESCRIPTION OF TH EMBODIMENTS

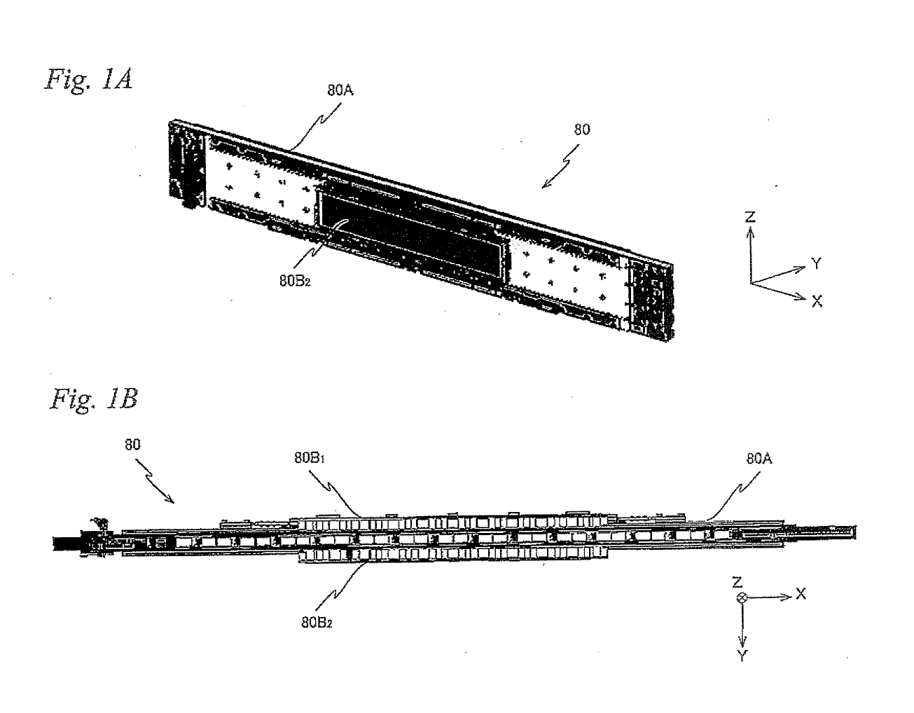

Hereinafter, an embodiment of the present invention will be described, using FIGS. 1 to 7.

FIG. 1A is a perspective view showing an external appearance of a linear motor 80 related to the present embodiment, and FIG. 18 is an XY sectional view of a schematic structure of linear motor 80. Linear motor 80 is a moving-magnet type linear motor which employs a driving method using the Lorentz force (electromagnetic force). Linear motor 80 is structured from a stator (hereinafter indicated using the same numerical references as coil unit 80A) consisting of a plate shaped coil unit 80A whose longitudinal direction is the driving direction (X-axis direction in this case), and a mover (hereinafter indicated using the same numerical references as magnet units 80B₁ and 80B₂) consisting of magnet units 80B₁ and 80B₂ which are placed on both the front and rear surfaces (+−Y sides) of stator 80A.

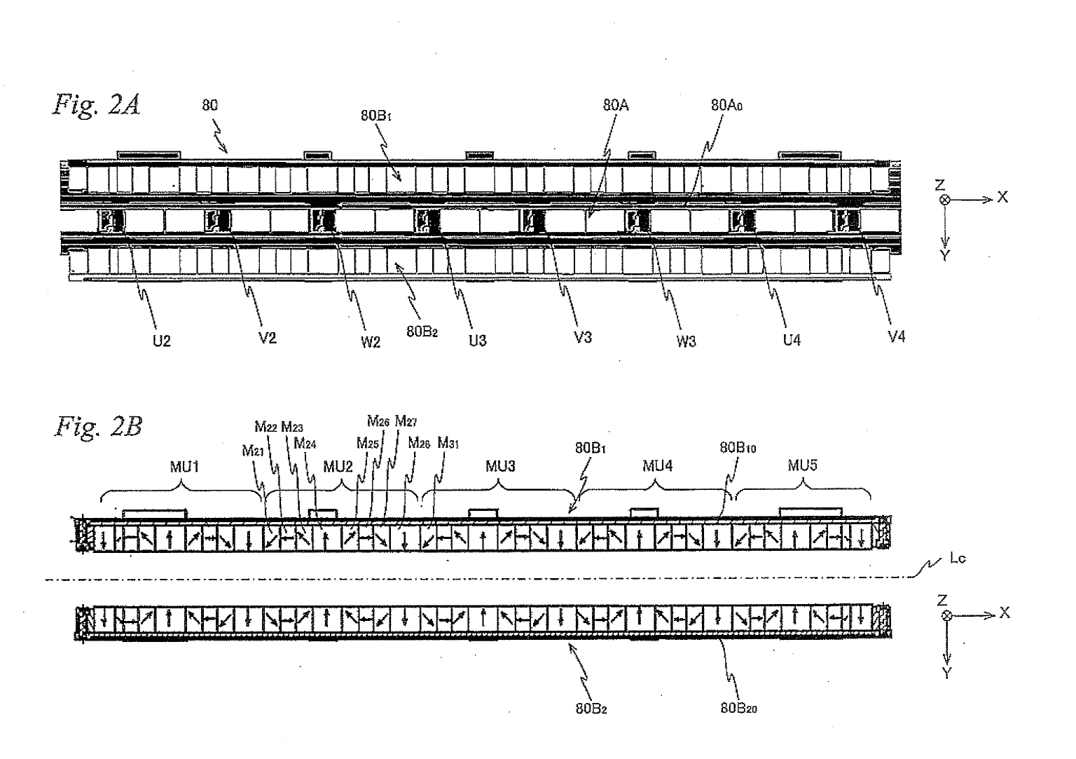

FIG. 2A shows a concrete structure of linear motor 80. Coil unit 80A includes 14 coils (five U-phase coils, five V-phase coils, and four W-phase coils) which make up a three-phase coil. FIG. 2A shows eight coils; U2, V2, W2, U3, V3, W3, U4, and V4. These coils are arranged spaced constantly apart in the X-axis direction inside a base 80A₀ which is made of a nonmagnetic body.

As shown in FIG. 2B, magnet unit 80B₁ includes 40 permanent magnets (hereinafter, simply called magnets) Mᵢⱼ (i=1 to 5, j=1 to 8), arranged in the X-axis direction on a yoke member 80B₁₀. As magnet Mᵢⱼ, a rare earth-containing magnet is employ such as, for example, neodymium iron boron magnet (Nd₂Fe₁₄B). Further, as yoke member 80B₁₀, a magnetic body is employed which has high permeability and large saturation magnetization. Incidentally, the magnet unit can be configured, for example, by preparing 40 magnets individually, or by dividing one magnet into 40 areas according to the directions of the magnetic poles.

In magnet Mᵢⱼ, 8 magnets (for example, magnets M₂₁, M₂₂, M₂₃, M₂₄, M₂₅, M₂₆, M₂₇, and M₂₈) whose directions of the magnetic poles within an XY plane and widths in the X-axis direction are different serve as a unit (unit MU2), which is classified into one of five units MU1 to MU5. FIGS. 2A and 2B show magnets which are facing 8 coils U2, V2, W2, U3, V3, W3, U4, and V4 within coil unit 80A.

Magnet unit 80B₂ is also configured in a similar manner as magnet unit 80B₁. However, magnet unit 80B₂ is placed so that the directions of the magnetic poles of the magnets within magnet unit 80B₂ are opposite to the directions of the magnetic poles of the magnets within magnet unit 80B₁, with the center (reference line Lc) of coil unit 80A serving as a reference.

The arrangement of the magnets in magnet units 80B₁ and 80B₂, or more specifically, the directions of the magnetic poles in the XY plane and the widths in the X-axis direction of the magnets are decided so that a magnetic field (magnetic flux density) with a sinusoidal distribution is induced on the center (reference line Lc) of coil unit 80A. In FIG. 2B, the directions of the magnetic poles of each magnet (directions from S-pole to N-pole) are indicated using arrows. The directions of the magnetic poles are shifted by an angle of 45 degrees with respect to the directions of the magnetic poles of adjacent magnets. For example, the directions of the magnetic poles of magnets M₂₁, M₂₂, M₂₃, M₂₄, M₂₅, M₂₆, M₂₇, and M₂₆ in unit MU2 rotate in sequence at an angle of −45 degrees, and the direction of the magnetic pole of magnet M₃₁ in unit MU3 adjacent to unit MU2 becomes the same as the direction of the magnetic pole of magnet M₂₁.

However, the angle shifted of the directions of the magnetic poles is not limited to 45 degrees. For example, a structure can be employed of rotating the directions of the magnetic poles by increasing the number of magnets to make the angle to be shifted smaller than 45 degrees. Further, the angle to be shifted can be set as required so that the directions of the magnetic poles return in the end to the original angle in one unit, without making the angle to be shifted equal between all the magnets.

The widths of the magnets in the X-axis direction are set so that magnets whose directions of the magnetic poles are in the Y-axis direction have larger widths than those of magnets whose directions of the magnetic poles are in other directions. For example, as for unit MU2, the widths of magnets M₂₄ and M₂₀ are larger than the widths of other magnets M₂₁, M₂₂, M₂₃, M₂₅, M₂₆, and M₂₇. The width of a unit in the X-axis direction is decided so that to an array pitch of one U-phase coil, V-phase coil, and W-phase coil each, two units of magnets are arranged. However, the widths of the magnets in the X-axis direction are not limited to these structures, and can be appropriately set.

A design method of a motor of the present invention will be described, using linear motor 80 described above as an example.

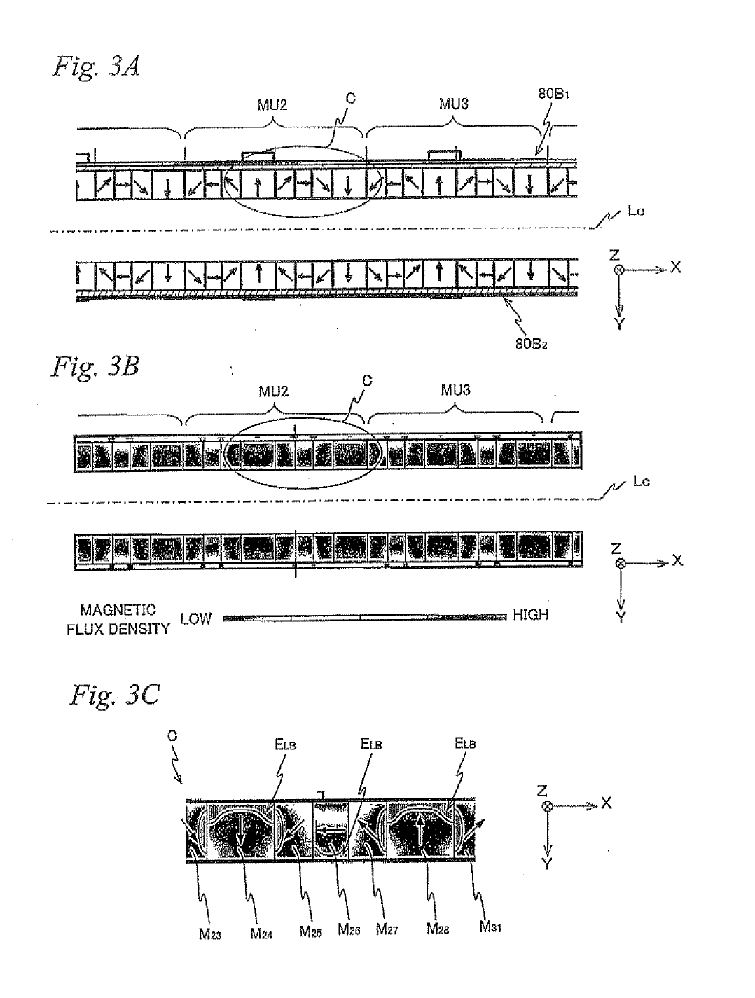

In a first step, linear motor 80, especially magnet units 80B₁ and 80B₂ (and coil unit 80A) included in linear motor 80 are designed. As previously described, corresponding to the structure (arrangement of coils and the like) of coil unit 80A, the arrangement of magnets Mᵢⱼ (i=1 to 5, j=11 to 8) on yoke members 80B₁₀ and 80B₂₀ inside magnet units 80B₁ and 80B₂, namely, the directions of the magnetic poles, the width and the like of each magnet, are decided so as to induce a magnetic field of a predetermined magnetic flux density distribution on reference line Lc (for example, a position where coil unit 80A is located at the time of driving). According to this arrangement, magnet units 80B₁ and 80B₂ are designed, as shown in FIG. 3A.

In a second step, a magnetic field is analyzed, which is induced by magnets Mᵢⱼ in magnet units 80B₁ and 80B₂ designed in the manner described above, or namely, in a magnetic circuit structured by magnets Mᵢⱼ (i=1 to 5, j=1 to 8), yoke members 80B₁₀ and 80B₂₀, and the like. For the analysis, for example, an electromagnetic field analysis using a finite element method can be employed. Further, in the analysis, adding to the placement and the like of magnets Mᵢⱼ and yoke members 80B₁₀ and 80B₂₀ decided above, properties of each magnet such as residual magnetic flux density, coercivity, permeability and the like determined by the composition of the magnets, permeability (furthermore, dependence of the permeability on the intensity of the magnetic field) of the yoke members and the like are considered.

From magnetization I and intensity of magnetic field H that each magnet has, a magnetic field (magnetic flux density) B induced by magnets Mᵢⱼ is given, as B=I+μH. Here, coefficient μ is permeability. Inside the magnets, because magnetization I itself induces a demagnetizing field Hd(>0), magnetic flux density B becomes smaller than magnetization I only by an amount of the magnetic flux density occurring due to demagnetizing field Hd. Further, because magnetic fields induced by magnetization of adjacent magnets and magnetization of yoke members 80B₁₀ and 80B₂₀ act as a demagnetized field (magnetized field), magnetic flux density B becomes smaller (or larger).

According to the magnetic field analysis described above, the magnetic field (magnetic flux density distribution) inside the magnets is obtained, as shown in FIG. 3B. FIG. 3C shows an enlarged view of the magnetic flux density distributions inside magnets M₂₃, M₂₄, M₂₅, M₂₆, M₂₇, M₂₈, and M₃₁ indicated by an ellipse C in FIGS. 3A and 3B. In an area E_{LB} inside the magnets, such as for example, the −Y section of magnet M₂₄ whose direction of the magnetic pole is in the +Y direction, the vicinity of the border with magnet M₂₄ of magnets M₂₃ and M₂₅ positioned on both sides of magnet M₂₄, the +Y section of magnet M₂₆ whose direction of the magnetic pole is in the −X direction, the −Y section of magnet M₂₉ whose direction of the magnetic pole is in the −Y direction, and the vicinity of the border with magnet M₂₈ of magnets M₂₇ and M₃₁ positioned on both sides of magnet M₂₈, it can be seen that the magnetic field is weaker (magnetic flux density is lower) than other areas.

In the above analysis results, this means that in area E_{LB} where the magnetic field is weak, the demagnetizing field induced by the magnetization that each magnet has, the magnetic field generated by the adjacent/opposing magnets, or the demagnetized field (to be collectively called a demagnetized field) induced by the yoke member (or the space formed with coil unit 80A) is strong. When intensity H′ of such demagnetized field is larger than coercivity Hc of each magnet (H′>Hc), the magnet is demagnetized, which decreases its function as a magnet. Accordingly, H′>Hd is to be obtained so that magnets Mᵢⱼ(i=1 to 5, j=1 to 8) serve as magnets structuring magnet units 80B₁ and 80B₂. Meanwhile, as for other areas having a strong magnetic field, this means that demagnetization field H′ is weak. In such areas, even if coercivity Hc is somewhat smaller, the magnet is not demagnetized. Accordingly, only in area E_{LB} within magnets Mᵢⱼ (i=1 to 5, j=1 to 8) where the magnetic field is weak, coercivity Hc higher than the other areas having a stronger magnetic field becomes necessary.

To obtain higher coercivity Hc, an element to increase coercivity Hc can be added to the rare earth-containing magnet, which is the neodymium iron boron magnet (Nd₂Fe₁₄B) as previously described. Here, dysprosium Dy will be chosen. This allows high coercivity Hc, and will also make demagnetization difficult under an environment of high temperature. However, there is a problem of dysprosium Dy being expensive, and having an unstable cost. Further, adding dysprosium Dy causes a decrease in residual magnetic flux density Br.

Therefore, in a third step, based on the above analysis results, addition distribution of dysprosium Dy is decided so that dysprosium Dy is added only in area (the area having a strong demagnetized field) E_{LB} having a weak magnetic field within the magnet, or a relatively higher amount of dysprosium Dy is added to area E_{LB} than the other areas. Here, the addition distribution is decided to be equal to area E_{LB}. This allows high coercivity Hc to be obtained in area E_{LB}, and in the other areas, residual magnetic flux density Br is maintained strongly. Accordingly, in the individual magnets considered as a whole, both the residual magnetic flux density and coercivity are improved using a small amount of dysprosium Dy, and a magnet having strong magnetic force and high heat-resisting performance can be obtained.

Further, along with deciding the addition distribution of an element to improve coercivity Hc, for example, a distribution of adding an element to improve residual magnetic flux density Br, or a distribution of adding an element to improve heat-resisting performance can also be decided. In such a case, because priority is given to adding elements that improve coercivity Hc, these distributions should be decided so that the elements are added to areas other than area E_{LB}, relatively more than the amount added to area E_{LB}.

Incidentally, in the second step, while the area where the magnetic field is weaker than a predetermined threshold value (the magnetic flux density is lower than the threshold value) is obtained as area E_{LB}, in the third step, in order to obtain high residual magnetic flux density and high coercivity using a small amount of dysprosium Dy, the threshold value has to be appropriately selected based on the placement of each magnet, that is, the directions of the magnetic poles, residual magnetic flux density, coercivity and the like. As an example, the threshold value is preferably given with a magnetic flux density at the maximum inflection point of a demagnetizing curve for each magnet, an average of the magnetic flux density inside each magnet and the like, serving as a reference. Further, in the present embodiment, while only one threshold value was set, the threshold value is not limited to this. For example, a plurality of threshold values can be set based on the magnitude of the magnetic flux density of the magnets, and the amount of dysprosium Dy added, the distribution state of dysprosium Dy, or both the amount and the distribution state can be decided according to each threshold value.

In a fourth step, dysprosium Dy is added based on the distribution of addition obtained above, and magnets Mᵢⱼ (i=1 to 5, j=1 to 8) are each structured. As shown in FIG. 3C, here, area E_{LB} is in contact with a part of the border of the magnets. Therefore, for example, by applying dysprosium oxide, dysprosium fluoride, or an alloy powder containing dysprosium to the surface of the part of the border of the magnets and performing a high-temperature processing to diffuse dysprosium Dy inside the magnets, dysprosium Dy can be added restricting the area to area E_{LB}. Incidentally, details on addition of elements such as dysprosium Dy and the like are disclosed, for example, in Kokai (Japanese Unexamined Patent Application Publication) No. 2010-135529 (the corresponding U.S. Patent Application Publication No. 2011/0210810).

Magnet units 80B₁ and 80B₂ are designed using magnets Mᵢⱼ (i=1 to 5, j=1 to 8) structured in the manner described above, and linear motor 80 is structure using magnet units 80B₁ and 80B₂.

Here, the arrangement (of the directions of the magnetic poles, width and the like of each magnet) of magnets Mᵢⱼ (i=1 to 5, j=1 to 8) within magnet units 80B₁ and 80B₂ can be decided again (perform step 1), and then steps 2, 3, and 4 can be repeatedly performed. This makes it possible to design linear motor 80 which has a more suitable structure.

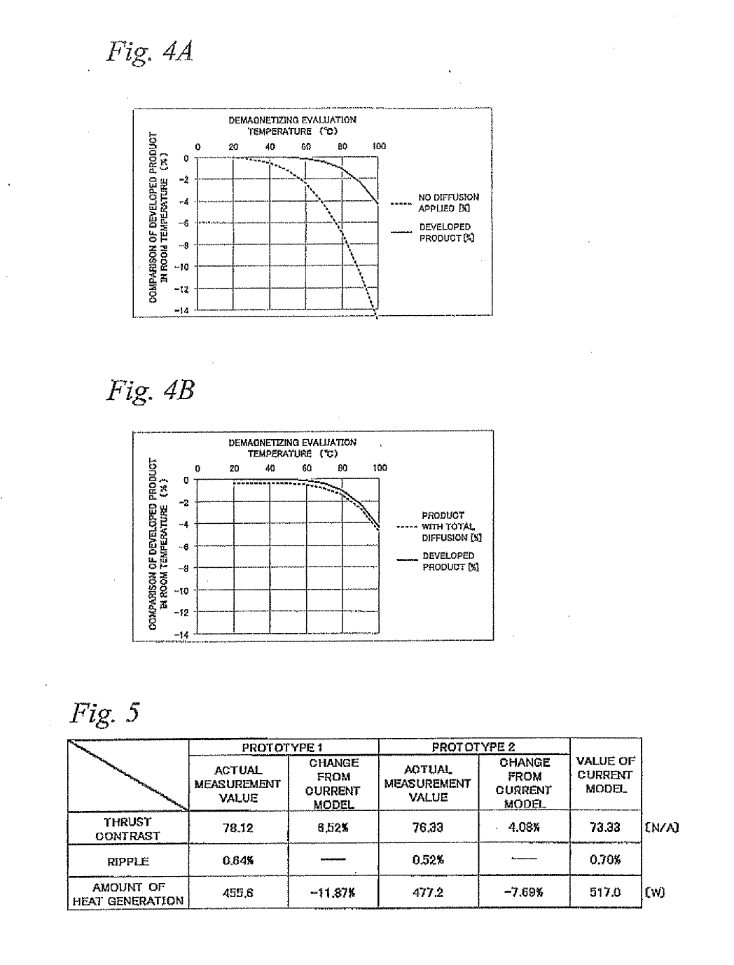

Demagnetization properties were evaluated of a magnet structured in the manner described. The evaluation results are indicated in FIGS. 4A and 4B. While it can be seen from FIG. 4A that demagnetization occurs at a temperature equal to or higher than room temperature (of around 20 degrees) in the magnet without dysprosium Dy added, demagnetization does not occur until around 60 degrees in the magnet (developed product) of the present embodiment. Incidentally, the temperature of 60 degrees is the upper limit of the environmental temperature in which the linear motors are used in exposure apparatus 10 that will be described later on. Further, from FIG. 4B, while it can be seen that the magnet to which dysprosium Dy has been added entirely shows the same demagnetization properties as the demagnetization properties of the magnet of the present embodiment, the magnetic force is weak. Accordingly, it can be seen that a magnet having strong magnetic force and high heat-resisting performance has been obtained by effectively improving both the residual magnetic flux density and coercivity using a small amount of dysprosium Dy.

When the design of the present embodiment is used, because dysprosium Dy is diffused locally and selectively, and is not diffused evenly throughout the magnets Mᵢⱼ (i=1 to 5, J=1 to 8), the amount of dysprosium Dy added can be reduced. In this case, in each magnet, it can be said that the positional relation between the direction of the magnetic flux and the area where dysprosium Dy is distributed differs depending on which section the magnet is placed in the magnetic circuit. For example, as for magnet M₂₄ in magnet unit 80B₁, when the direction of the magnetic pole is in a first direction (in this case, −Y direction), dysprosium Dy is distributed in an area where dysprosium Dy is in a first state with respect to the first direction (distributed on the tip side of the arrow indicating the magnetic pole direction), whereas, regarding magnet 28, when the direction of the magnetic pole is in a second direction (in this case, +Y direction), dysprosium Dy is distributed in an area where dysprosium Dy is in a second state different from the first state with respect to the second direction (distributed on the rear end side of the arrow indicating the magnetic pole direction).

Incidentally, in the above embodiment, while the distribution of area E_{LB} was obtained for all of the magnets Mᵢⱼ (i=1 to 5, j=1 to 8), and dysprosium Dy was added selectively in the areas, the present embodiment is not limited to this structure. For example, when the design method of the present embodiment is applied only to magnets (areas) having magnetic poles in one predetermined direction in one unit of MU1 to MU5, a similar effect can be obtained at least regarding such magnets.

Evaluation was performed of the performance of linear motor 80 designed and manufactured using the magnet described above. FIG. 5 shows evaluation results concerning two prototypes (No. 1 and No. 2) and a current model. In the two prototypes, compared to the current model, magnetic flux density was improved by 4.0% and 2.5% (not shown), thrust constant was improved by 6.52% and 4.08%, and the amount of heat generation was reduced by 11.87% and 7.69%.

Exposure apparatus 10 structured using linear motor 80 designed and manufactured in the manner described above will be described.

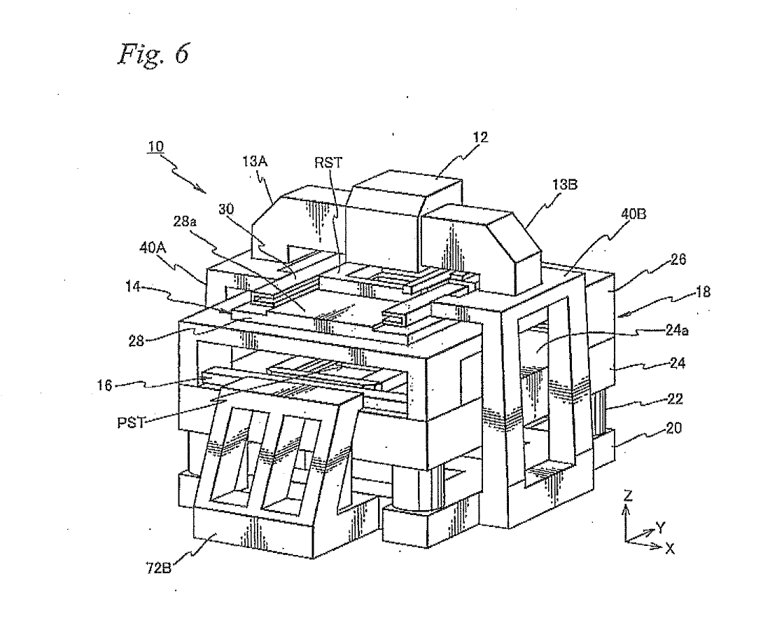

FIG. 6 shows a schematic configuration of exposure apparatus 10 related to the present embodiment. Exposure apparatus 10 is a scanning type exposure apparatus for liquid crystals used to transfer a pattern of a reticle serving as a mask onto a glass plate for liquid crystals serving as a substrate, using a step-and-scan method.

Exposure apparatus 10 is equipped with an illumination system 12, a reticle stage device 14, a plate stage device 16, a projection optical system which is not shown, a main section column 18 in which the projection optical system is provided and the like.

Main section column 18 is structured from a surface plate 24 horizontally held via a plurality of (in this case, four) vibration isolation pads 22 on the upper surface of a base frame (frame caster) 20 mounted on an installation floor, a first column 26 fixed on surface plate 24, a second column which is not shown provided on the first column 26 and the like.

Of the sections, surface plate 24 structures a base of a plate stage which will be described later on, and a movement plane 24a of the plate stage is formed on the upper surface of surface plate 24.

In the first column 26, the projection optical system which is not shown is held with the optical axis direction serving as a Z-axis direction. As the projection optical system, a double telecentric dioptric system is used here that has a projection magnification, for example, of equal magnification.

The second column is fixed to the upper surface of the first column 26 in a state surrounding the projection optical system, and on the second column, a reticle stage base 28 shown in FIG. 6 is fixed horizontally. A movement plane 28a of a reticle stage RST is formed on the upper surface of reticle stage base 28.

Vibration from the installation floor to main section column 18 structured in the manner described above is insulated at the micro-g level by vibration isolation pads 22.

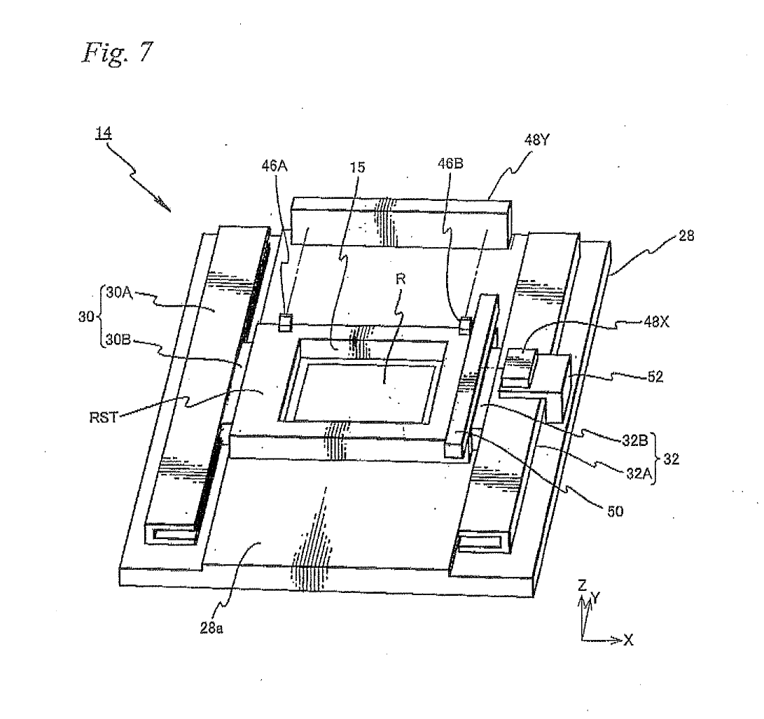

Illumination system 12 is structured with a light source unit, a shutter, a secondary light source forming optical system, a beam splitter, a condensing lens system, a reticle blind, an image-forming lens system and the like (each of which are not shown) as disclosed in, for example, Kokai (Japanese Unexamined Patent Application Publication) No. 9-320956, and illuminates a rectangular shaped (or an arc shaped) illumination area on reticle R (refer to FIG. 7) held on reticle stage RST with a uniform illuminance. Illumination system 12, as shown in FIG. 6, is supported on the upper part of reaction force cancelling frames 40A and 40B serving as a pair of holding members provided separately from main section column 18, via a pair of support members 13A and 13B, respectively. The lower ends of reaction force cancelling frames 40A and 40B are connected to the installation floor at the sides of base frame 20.

Reticle stage device 14, as shown in FIG. 7, is equipped with reticle stage RST, and a pair of linear motors 30 and 32 structuring a driver which drives reticle stage RST along movement plane 28a.

More particularly, a plurality of air pads which are not shown are placed on the lower surface of reticle stage RST, and these air pads support reticle stage RST by levitation via a predetermined clearance with respect to movement plane 28a. In the center of reticle stage RST, a recess section 15 having a rectangular sectional shape is formed, and reticle R is made to be fixed to the inner bottom section of recess section 15 by vacuum suction and the like. In the inner bottom section (the rear surface side of reticle R) of recess section 15, a rectangular opening (omitted in drawings) is formed which forms a path of the illumination light.

Linear motor 30 is placed above reticle stage base 28 (refer to FIG. 6), and is structured from a stator (magneto stator) 30A made up of a magnetic pole unit which has a U-shaped cross-section and extends in a scanning direction (in this case, a Y-axis direction), and a mover (rotor) 30B made up of an armature unit which is integrally fixed to a side surface on one side in the X direction (−X side) of reticle stage RST. Stator 30A is actually fixed to the tip of a protruding portion on the upper part of reaction force cancelling frame 40A.

Linear motor 32, as shown in FIG. 7, is placed above reticle stage base 28 (refer to FIG. 6), and is structured from a stator (magneto stator) 32A made up of a magnetic pole unit which has a U-shaped cross-section and extends in the Y-axis direction, and a mover (rotor) 32B made up of an armature unit which is integrally fixed to a side surface on the other side in the X direction (+X side) of reticle stage RST. Stator 32A is actually fixed to the tip of a protruding portion on the upper part of reaction force cancelling frame 408.

As linear motors 30 and 32, linear motors are used that employ a driving method using the Lorentz force (electromagnetic force) whose structures are similar to linear motor 80 previously described. Magnetic pole units (stators 30A and 32A) and armature units (movers 30B and 32B) of linear motors 30 and 32 correspond to magnet units 80B₁ and 80B₂ and coil unit BOA of linear motor 80, respectively. However, linear motors 30 and 32 are moving-coil type motors, and the length of the magnetic pole unit and the driving direction (Y-axis direction) is shorter than the armature unit. Besides this point, linear motors 30 and 32 are structured in a similar manner as linear motor 80.

As described in detail so far, according to linear motor 80 of the present embodiment, its design method, and its manufacturing method, the magnetic field induced by the plurality of magnets Mᵢⱼ (i=1 to 5, j=1 to 8) included in magnet units 80B₁ and 80B₂ which are arranged corresponding to coil unit 80A is analyzed, and based on the results of the analysis, the distribution is decided of the elements which improves the coercivity inside each magnet, and based on the distribution, each of the plurality of magnets are structured. This makes it possible to realize a permanent magnet having strong magnetic force and high heat-resisting performance whose residual magnetic flux density and coercivity are both improved, using a small amount of an element which improves coercivity. And, by designing a magnet unit using the permanent magnet, and a motor using the magnet unit, it becomes possible to design and manufacture a motor with high performance that has a large driving force and is drivable at a high speed.

Further, reticle stage device 14 of the present embodiment uses linear motors 30 and 32 structured in a similar manner as linear motor 80, as a driving source. By this arrangement, a stage device can be obtained with high performance that can drive reticle stage RST at a high speed.

Further, exposure apparatus 10 of the present embodiment is equipped with reticle stage device 14 which uses linear motors 30 and 32 having a structure similar to linear motor 80. By this arrangement, an exposure apparatus can be obtained which drives a mask at a high speed and has a high throughput.

Incidentally, while linear motors 30 and 32 structured similar to linear motor 80 of the present invention were used as the driving source of reticle stage RST in reticle stage device 14 and exposure apparatus 10 of the present embodiment, linear motors 30 and 32 can also be used as the driving source of plate stage PST in plate stage device 16.

Further, in the above embodiment, while the scanning type exposure apparatus for liquid crystals equipped with linear motors structured similar to linear motor 80 was described, besides such apparatuses, it is a matter of course that the linear motor structured similar to linear motor 80 and the stage device equipped with such linear motor can also be applied in a similar manner to a scanning stepper used when manufacturing semiconductor devices. Further, the present embodiment can also be suitably applied, as a matter of course, to exposure apparatuses like a stationary type exposure apparatus such as a projection exposure apparatus (a so-called stepper) and the like using a step-and-repeat method, or to an electron beam exposure apparatus (EB exposure apparatus), or also to a laser repair apparatus or other apparatuses equipped with an XY stage.

Further, the design method and manufacturing method of linear motor 80 in the above embodiment is not limited to linear motors, and can also be used in rotary motors and planar motors.

Further, linear motor 80 of the above embodiment is not limited to usage in stage devices and exposure apparatuses, and can also be suitably used in linear motor cars, electric cars, hybrid cars and the like, in motors used in a high temperature environment.

Incidentally, the disclosures of all the U.S. patent application Publications and the U.S. patents that are cited in the description so far related to exposure apparatuses and the like are each incorporated herein by reference.

While the above-described embodiment of the present invention is the presently preferred embodiment thereof, those skilled in the art of lithography systems will readily recognize that numerous additions, modifications, and substitutions may be made to the above-described embodiment without departing from the spirit and scope thereof. It is intended that all such modifications, additions, and substitutions fall within the scope of the present invention, which is best defined by the claims appended below.

1-24. (canceled)

25. A design method of a motor which is structured using a magnet unit including a plurality of magnets and a coil unit including a plurality of coils, the method comprising:
deciding a distribution of an element which improves coercivity inside the plurality of magnets for each of the plurality of magnets, based on results of an analysis performed of a magnetic field induced by the plurality of magnets included in the magnet unit arranged corresponding to the coil unit; and
designing the magnet unit using the plurality of magnets which are each structured based on the distribution of the element which improves the coercivity.

26. The design method of a motor according to claim 25 wherein
in the deciding, the distribution of the element which improves the coercivity is decided from a distribution of an area whose intensity of the magnetic field inside each of the plurality of magnets is smaller than a threshold value.

27. The design method of a motor according to claim 26 wherein
the distribution of the element which improves the coercivity is decided so that the area whose intensity of the magnetic field in each of the plurality of magnets is smaller than the threshold value contains more of the element which improves the coercivity than an area whose intensity of the magnetic field is larger than the threshold value.

28. The design method of a motor according to claim 26 wherein
a distribution of an added element different from the element which improves the coercivity is decided so that an area whose intensity of the magnetic field in each of the plurality of magnets is larger than the threshold value contains more of the added element than the area whose intensity of the magnetic field is smaller than the threshold value.

29. The design method of a motor according to claim 26 wherein
the threshold value is decided from at least one of a direction of a magnetic pole, a residual magnetic flux density and the coercivity of each of the plurality of magnets.

30. The design method of a motor according to claim 26 wherein
the threshold value is given from a magnetic flux density at a maximum inflection point of a demagnetizing curve for each of the plurality of magnets.

31. The design method of a motor according to claim 25 wherein
the plurality of magnets are arranged to structure a magnetic flux density distribution that corresponds to a placement of a plurality of coils included in the coil unit on a reference plane of the coil unit.

32. The design method of a motor according to claim 25 wherein
in the designing, the plurality of magnets which are structured by partially adding the element to improve the coercivity are used, based on the distribution of the element which improves the coercivity.

33. The design method of a motor according to claim 25 wherein
each of the plurality of magnets is a rare earth-containing magnet which contains at least Nd₂Fe₁₄B, and
the element which improves the coercivity is dysprosium.

34. The design method of a motor according to claim 25 wherein
the motor is a linear motor in which one of the magnet unit and the coil unit serves as a mover and the other serves as a stator, and the mover moves in a uniaxial direction with respect to the stator.

35. A manufacturing method of a motor, comprising:
designing a motor using the design method of a motor according to claim 25; and
manufacturing the motor according to results of the designing.

36. A motor which is designed using the design method of a motor according to claim 25, and is manufactured according to results of the design.

37. A motor which is structured using a magnet unit including a plurality of magnets and a coil unit including a plurality of coils, wherein
the magnet unit is designed using the plurality of magnets which are each structured based on a distribution of an element which improves coercivity inside the plurality of magnets for each of the plurality of magnets, the distribution being decided based on results of analyzing a magnetic field induced by the plurality of magnets included in the magnet unit arranged corresponding to the coil unit.

38. The motor according to claim 37 wherein
the distribution of the element which improves the coercivity is decided from a distribution of an area whose intensity of the magnetic field inside each of the plurality of magnets is smaller than a threshold value.

39. The motor according to claim 38 wherein
the distribution of the element which improves the coercivity is decided so that the area whose intensity of the magnetic field in each of the plurality of magnets is smaller than the threshold value contains more of the element which improves the coercivity than an area whose intensity of the magnetic field is larger than the threshold value.

40. The motor according to claim 38 wherein
a distribution of an added element different from the element which improves the coercivity is decided so that an area whose intensity of the magnetic field in each of the plurality of magnets is larger than the threshold value contains more of the added element than the area whose intensity of the magnetic field is smaller than the threshold value.

41. The motor according to claim 38 wherein
the threshold value is decided from at least one of a direction of a magnetic pole, a residual magnetic flux density and the coercivity of each of the plurality of magnets.

42. The motor according to claim 38 wherein
the threshold value is given from a magnetic flux density at a maximum inflection point of a demagnetizing curve for each of the plurality of magnets.

43. The motor according to claim 37 wherein
the plurality of magnets are arranged to structure a magnetic flux density distribution that corresponds to a placement of a plurality of coils included in the coil unit on a reference plane of the coil unit.

44. The motor according to claim 37 wherein
the plurality of magnets which are structured by partially adding the element to improve the coercivity are used, based on the distribution of the element which improves the coercivity.

45. The motor according to claim 37 wherein
the plurality of magnets are each a rare earth-containing magnet which contains at least Nd₂Fe₁₄B, and
the element which improves the coercivity is dysprosium.

46. The motor according to claim 37 wherein
the motor is a linear motor in which one of the magnet unit and the coil unit serves as a mover and the other serves as a stator, and the mover moves in a uniaxial direction with respect to the stator.

47. A stage device, comprising:
the motor according to claim 46;
a stage support member in which one of the magnet unit and the coil unit structuring the motor is provided; and
a stage in which the other of the magnet unit and the coil unit is provided, and is supported by the stage support member.

48. An exposure apparatus which transfers a pattern formed on a mask onto an object, the apparatus comprising:
the stage device according to claim 47 serving as a moving device of at least one of the mask and the object.
